(19) United States
(12) Patent Application Publication
(10) Pub. No.: US 2009/0165358 A1
(43) Pub. Date: Jul. 2, 2009

(54) Fishing case

(76) Inventor: Charles Tough, Medicine Hat (CA)

Correspondence Address: Jim Helfrich, 200 Choteau ST, Sun River, MT, 59483, US

(21) Appl. No.: 12/003,503

(22) Filed: Dec. 26, 2007

(51) Int. Cl. A01K 97/06; A01K 97/08

(52) U.S. Cl. 43/54.1; 43/55; 206/315.11

(57) ABSTRACT

A fishing case equipped with compartments to separate, organize and contain all necessary tackle required in an easily accessible manor by the fisherman including pole, real, hooks, lures and bait in a secure protected manner. The entire case is constructed of a durable moldable material shaped in an rectangular tube with two outer shells that open on one side with hinges and both closeable and lockable for security and containment purposes. Each of the multiple compartments is self contained with its own openable and securable compartment to enable organization of the items carried as well as a separate insulated bait compartment permitting the carrying of live baits.

### RELATED APPLICATIONS

The present application is related to U.S. Pat. No. 5,046,279, issued Sep. 10, 1991, included by reference herein. The present application is related to U.S. Pat. No. 318,371, issued Jul. 23, 1991, included by reference herein.

### FIELD OF THE INVENTION

The present invention relates to a carrying case for fishing tackle and, more particularly, to fishing case that serves as a tackle and bait box permitting the fisherman's entire needs to be carried in one case.

### BACKGROUND OF THE INVENTION

When a person is traveling to a fishing location there is a need to provide both protection and organization to his or her fishing tackle. Transportation by its nature is rough and shock and vibration occur as well as little care in how packages or equipment is handled. This issue can cause equipment to be broken, damaged or lost. Efficiency and restrictions require that extras such as fishing tackle be carried in compact cases to prevent the extra cost associated with additional luggage imposed by travel providers. In addition the organization of the items is paramount to convenience and time efficiency. No one wants to spend hours sorting and reorganizing equipment after traveling to the destination. No case provides the ability to eliminate all of these problems by itself and currently one must purchase, carry, check and pay for travel costs on multiple cases to accomplish this task.

Carrying cases for fishing rods are well known. The earliest cases comprised of cloth covers while latter examples included hollow tubes and eventually rectangular box styles were used to provide more room for more equipment. Some used a shortened style to make travel easier and required the fishing pole be partially or completely disassembled. Examples of these cases are shown in prior art such as U.S. Pat. No. 5,046,279 and U.S. DES Pat. No. 318,371.

The problem with all of these examples is their inability to provide multi functional tasks requiring that additional cases be carried to handle fishing accessories such as tackle, hooks, lures, flies, and bait. Commercial and private passenger carriers restrict the number and size of luggage that can be carried with the passenger. If the passenger exceeds these limitations additional charges are levied. In the example of a small private plane transporting a passenger into a remote area it may mean a second flight costing the travel double in cost and a loss of time waiting for their equipment to arrive.

It is therefore an object of the invention to eliminate multiple carrying cases.

It is another object of the invention to provide for organized and safe transport of the fishing tackle and related items.

It is another object of the invention to reduce cost of case (s) and space when transporting fishing tackle.

It is another object of the invention to secure means of transporting expensive fishing equipment by public transportation.

### SUMMARY OF THE INVENTION

In accordance with the present invention, there is provided a fishing case equipped with compartments to separate, organize and contain all necessary tackle required in an easily accessible manor by the fisherman including pole, real, hooks, lures and bait in a secure protected manner. The entire case is constructed of a durable moldable material shaped in an rectangular tube with two outer shells that open on one side with hinges and both closeable and lockable for security and containment purposes. Each of the multiple compartments is self contained with its own openable and securable compartment to enable organization of the items carried as well as a separate insulated bait compartment permitting the carrying of live baits.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a right top perspective view of an improved fishing case in the closed position displaying the grip and carrying strap;

FIG. 2 is an inside perspective view of an opened improved fishing carrying case with all of its internal compartments in the closed position;

FIG. 3 is an inside exploded perspective view of an improved fishing case with most of the lids opened or removed;

FIG. 4 is an insulated compartment exploded perspective view of an insulated compartment with the lid and insulation removed from the compartment; and

FIG. 5 is a perspective view of an open zippered compartment.

For purposes of clarity and brevity, like elements and components will bear the same designations and numbering throughout the Figures.

### DESCRIPTION OF THE PREFERRED EMBODIMENT

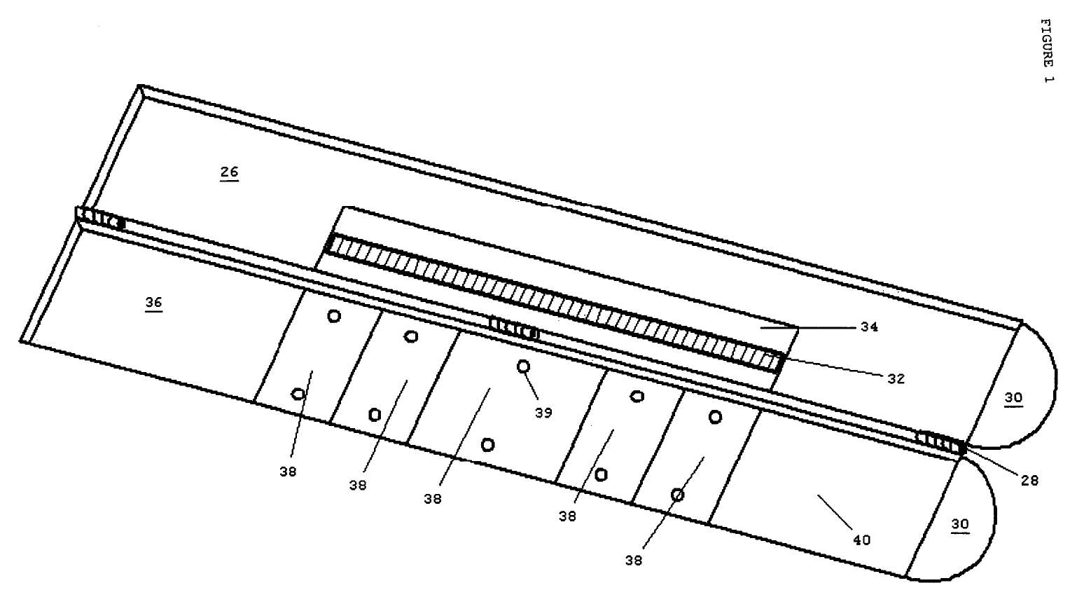

FIG. 1 is a right top perspective view of an improved fishing case in the closed position displaying the grip 14 and carrying strap.

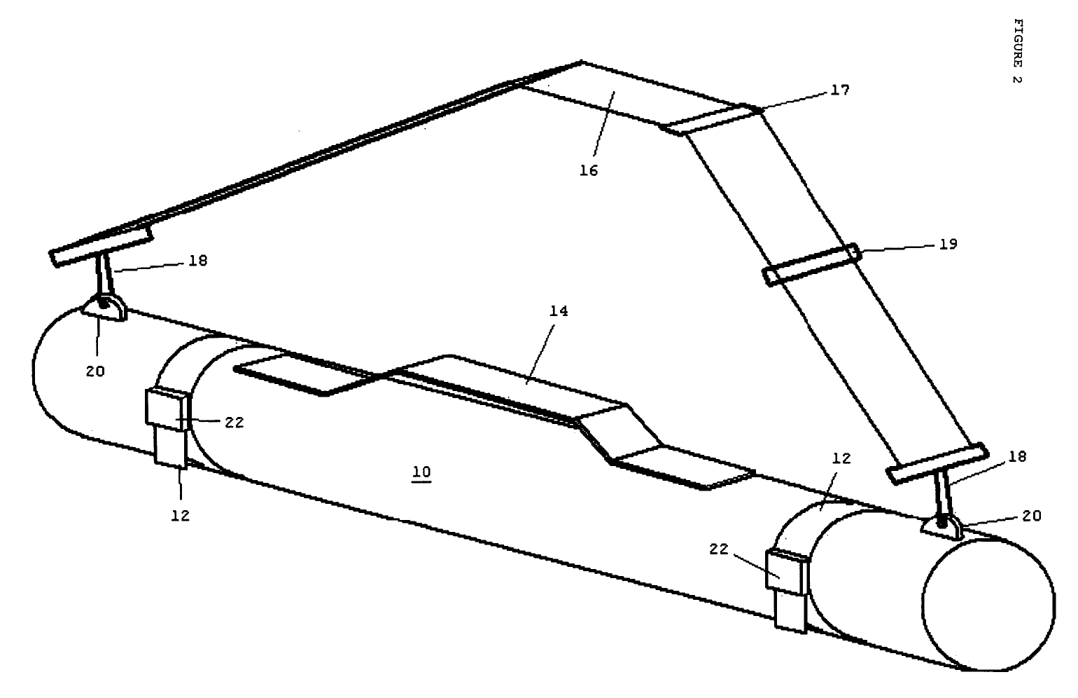

FIG. 2 is an inside perspective view of an opened improved fishing carrying case with all of its internal compartments in the closed position.

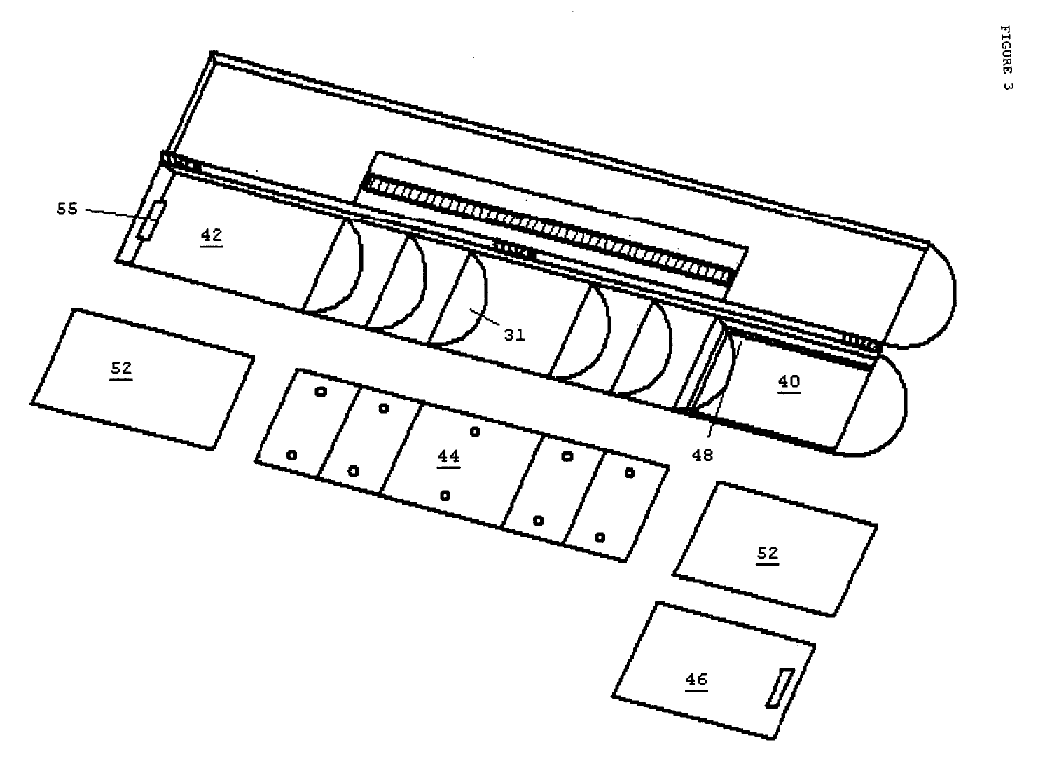

FIG. 3 is an inside exploded perspective view of an improved fishing case with most of the lids opened or removed.

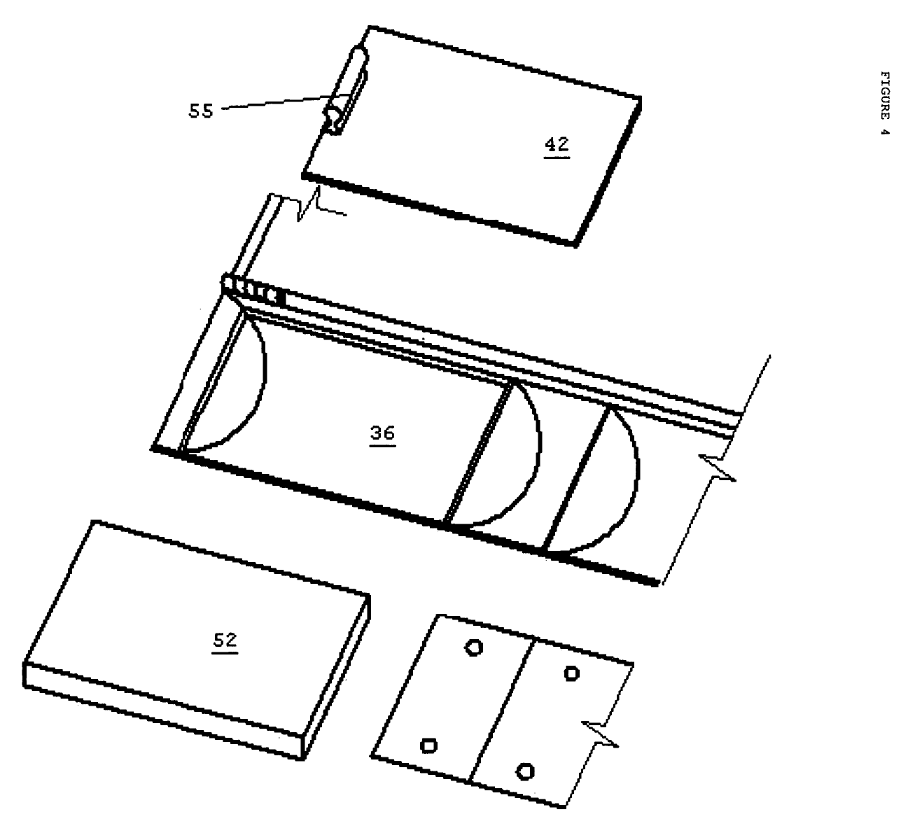

FIG. 4 is an insulated compartment 36 exploded perspective view of an insulated compartment 36 with the lid and insulation 52 removed from the compartment.

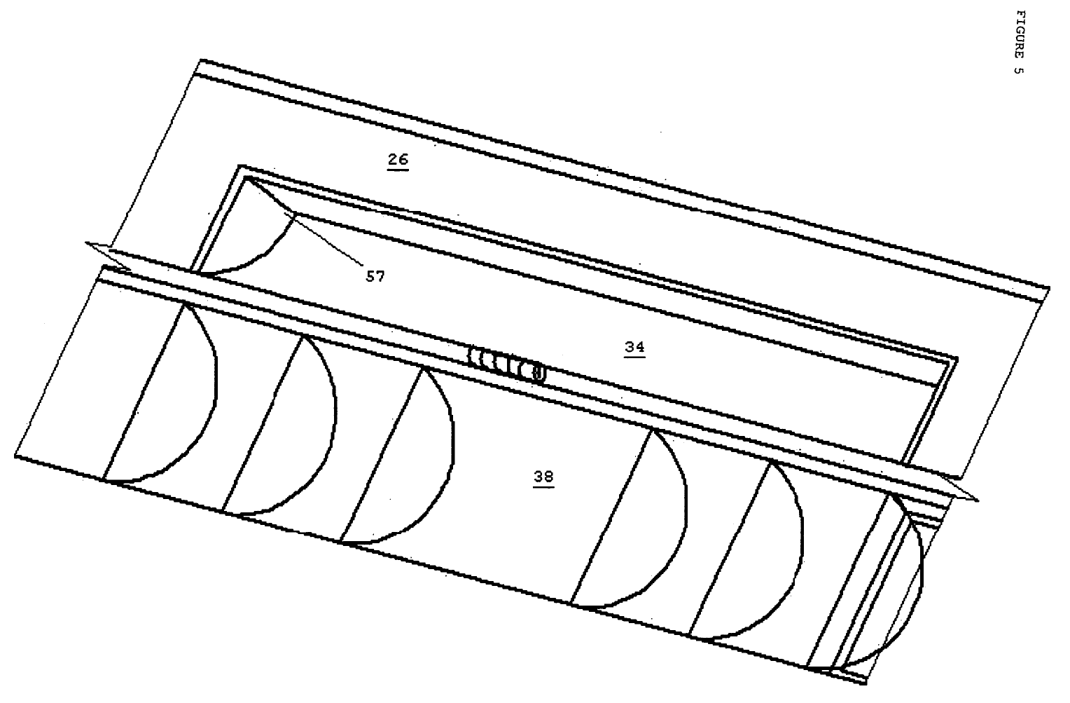

FIG. 5 is a perspective view of an open zippered compartment 34.

Referring now to FIG. 1, in a preferred embodiment of the invention a molded tube 10 is split in half and arranged to be fitted with at least one securing strap 12 encircling the tube 10 in such a manner as to prevent the tube 10 from opening or being opened without authorization. Strap locks 22 are fastened to the tube 10 to permit locking of the straps in their secure position. These strap locks 22 may be fitted with a key opening to permit securing the strap to unauthorized opening. A grip 14 is attached to one side of the tube 10 to permit easy carrying of the tube 10 by the placing one hand through the grip 14. A carry strap 16 is attached to one side of the tube 10 by means of strap connectors 18 that are removably attached to the tube 10 by means of connector protrusions 20 molded as part of the tube 10 structure and fitted with a hole of sufficient size to permit the strap connectors 18 to pass through and removably attach. A strap adjusting buckle 19 is fitted in the strap to permit the strap to be adjusted to fit the owner in a comfortable and practical manner. This adjustment is made easier by means of a strap divider 17 that permits movement of one end of the strap rather than requiring the entire strap to move when the strap adjusting buckle 19 is used.

Referring now to FIG. 2, in a most preferred embodiment of the invention the outer molded protective outside case 30 is configured in two halve conical portions. Each of these portions being concave in structure and containing at least one storage compartment 38. The two halves being moveably attached with more than one hinge 28 spaced proportionately along the connecting edge.

One half of said protective outside case 30 being occupied by at least one insulated compartment 36, at least one storage compartment 38 and at least one, water tight compartment 40. Such compartments being separated by a molded divider 31 (not shown) and covered with lids fitted with knobs 39 for easy removal of said lids.

The other half of the protective outside case 30 being occupied principally with padding 26 surrounding a zippered compartment 34 closed with an openable and closeable zipper 32. Said padding 26 being used to provide protection for various non uniform and miscellaneous shapes as is encountered with fishing equipment. The zippered compartment 34 being an elongated structure, molded into place portion occupying the principally central portion of the outer protective case.

Referring now to FIG. 3, in a most preferred embodiment of the present invention detail is shown in the open tube 10 configuration. A water tight compartment 40 is fitted with a water tight seal 48 to permit a water tight compartment lid 46 to seal and be covered with insulation 52 to keep temperature fluctuation to a minimum. Displaying the standard compartment lid 44 in the off position permitting a view of the individual compartments and the half circle shape of the compartment divider to be seen.

The insulated compartment 36 insulation 52 is shown removed from the insulated compartment lid 42 exposing the insulated compartment knob 55 used to remove the insulated compartment lid 42 from the insulated compartment 36.

Referring now to FIG. 4, in a most preferred embodiment of the present invention detail is shown of the insulated compartment 36. The rectangular Insulation 52 is shown removed from the rectangular insulated compartment lid 42 as well as the insulated compartment lid 42 removed from the insulated compartment 36 with the insulated compartment knob 55 non removably attached. The upper edge of the insulated compartment 36 is of sufficient thickness that a support is provided for the insulated compartment lid 42. The sufficient thickness is caused by the thickness of a separate insulation 52 material that surrounds the insulated compartment 36 to impede temperature change in the compartment. The insulation 52 material being composed of any formable material with good insulation 52 capabilities.

Referring now to FIG. 5, in a most preferred embodiment of the present invention detail is shown of the zippered compartment 34. The rectangular top and half conical shape of the compartment is configured to fit the general shape of the protective outside case 30 and being surrounded by padding 26 in the remaining portions of the protective outside case 30 not occupied by the zippered compartment 34. The compartment itself consisting of a molded material 57 to retain the shape and protective abilities of the compartment.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An improved fishing case for safely and efficiently carrying fishing tackle, bait and accessories, comprising: means for containing the compartments and fishing equipment. it provides for a secure, protective, enclosure that permits easy carrying, securable protection and serves as a foundation for interior compartments;
means for placing the two halves of the tube into a closed and securable position. preventing others from accessing the contents without proper authorization;
means for locking the securing straps to prevent accidental or unauthorized entry into the tube;
means for providing a soft padded location to safely store fishing rods, reels and other fishing components while the tube is being carried in a commercial carrier or by a person. to protect the contents from damage against shock and jarring;
means for providing an openable storage compartment with in the padded and hard bodied portion of the tube;
means for providing an isolated compartment to store various fishing items in while traveling or while in storage;
means for providing a positive division between compartments. also for providing a location for the compartment lid to fit and seal;
means for providing a compartment that is insulated to protect such items as bait from the ill effects caused by excessive heat;
means for storing various fishing components such as fishing tackle or hardware to prevent it from being mixed or tangled with other fishing tackle or hardware;
means for containing live bait within to maintain its live vigorous condition;
means for containing the contents of the compartment within said compartment and permitting entry into said compartment when desired;
means for securing the contents of a compartment within said compartment and permitting entry into said compartment when desired;
means for sealing the water tight compartment in a watertight condition and allowing entry into said compartment when desired;
means for providing a seal between the lid and the compartment to prevent water from escaping from the compartment; and
means for providing shape and structure to the compartment so that the contents may be both protected and contained within.

2. The improved fishing case in accordance with claim 1, wherein said means for containing the compartments and fishing equipment. it provides for a secure, protective, enclosure that permits easy carrying, securable protection and serves as a foundation for interior compartments comprises a tubular, rigid tube.

3. The improved fishing case in accordance with claim 1, wherein said means for placing the two halves of the tube into a closed and securable position. preventing others from accessing the contents without proper authorization comprises a flexible, durable, securably fastenable securing strap.

4. The improved fishing case in accordance with claim 1, wherein said means for locking the securing straps to prevent accidental or unauthorized entry into the tube comprises a durable, securable strap locks.

5. The improved fishing case in accordance with claim 1, wherein said means for providing a soft padded location to safely store fishing rods, reels and other fishing components while the tube is being carried in a commercial carrier or by a person. to protect the contents from damage against shock and jarring comprises a compressible, resilient, cushioning padding.

6. The improved fishing case in accordance with claim 1, wherein said means for providing an openable storage compartment with in the padded and hard bodied portion of the tube comprises a closeable, securable, openable zipper.

7. The improved fishing case in accordance with claim 1, wherein said means for providing an isolated compartment to store various fishing items in while traveling or while in storage comprises an isolated compartment zippered compartment.

8. The improved fishing case in accordance with claim 1, wherein said means for providing a positive division between compartments. also for providing a location for the compartment lid to fit and seal comprises a rigid, formable molded divider.

9. The improved fishing case in accordance with claim 1, wherein said means for providing a compartment that is insulated to protect such items as bait from the ill effects caused by excessive heat comprises an insulated, compartmentalized insulated compartment.

10. The improved fishing case in accordance with claim 1, wherein said means for storing various fishing components such as fishing tackle or hardware to prevent it from being mixed or tangled with other fishing tackle or hardware comprises a secureable storage compartment.

11. The improved fishing case in accordance with claim 1, wherein said means for containing live bait within to maintain its live vigorous condition comprises a leak resistant, secureable water tight compartment.

12. The improved fishing case in accordance with claim 1, wherein said means for containing the contents of the compartment within said compartment and permitting entry into said compartment when desired comprises a rectangular, rigid insulated compartment lid.

13. The improved fishing case in accordance with claim 1, wherein said means for securing the contents of a compartment within said compartment and permitting entry into said compartment when desired comprises a rectangular, rigid standard compartment lid.

14. The improved fishing case in accordance with claim 1, wherein said means for sealing the water tight compartment in a watertight condition and allowing entry into said compartment when desired comprises a sealable, rigid, rectangular water tight compartment lid.

15. The improved fishing case in accordance with claim 1, wherein said means for providing a seal between the lid and the compartment to prevent water from escaping from the compartment comprises a water resistant, leak resistant water tight seal.

16. The improved fishing case in accordance with claim 1, wherein said means for providing shape and structure to the compartment so that the contents may be both protected and contained within comprises a rigid, formable molded material.

17. An improved fishing case for safely and efficiently carrying fishing tackle, bait and accessories, comprising: a tubular, rigid tube, for containing the compartments and fishing equipment. it provides for a secure, protective, enclosure that permits easy carrying, securable protection and serves as a foundation for interior compartments;
a flexible, durable, securably fastenable securing strap, for placing the two halves of the tube into a closed and securable position. preventing others from accessing the contents without proper authorization;
a durable, securable strap locks, for locking the securing straps to prevent accidental or unauthorized entry into the tube;
a compressible, resilient, cushioning padding, for providing a soft padded location to safely store fishing rods, reels and other fishing components while the tube is being carried in a commercial carrier or by a person. to protect the contents from damage against shock and jarring;
a closeable, securable, openable zipper, for providing an openable storage compartment with in the padded and hard bodied portion of the tube;
an isolated compartment zippered compartment, for providing an isolated compartment to store various fishing items in while traveling or while in storage;
a rigid, formable molded divider, for providing a positive division between compartments. also for providing a location for the compartment lid to fit and seal;
an insulated, compartmentalized insulated compartment, for providing a compartment that is insulated to protect such items as bait from the ill effects caused by excessive heat;
a secureable storage compartment, for storing various fishing components such as fishing tackle or hardware to prevent it from being mixed or tangled with other fishing tackle or hardware;
a leak resistant, secureable water tight compartment, for containing live bait within to maintain its live vigorous condition;
a rectangular, rigid insulated compartment lid, for containing the contents of the compartment within said compartment and permitting entry into said compartment when desired;
a rectangular, rigid standard compartment lid, for securing the contents of a compartment within said compartment and permitting entry into said compartment when desired;
a sealable, rigid, rectangular water tight compartment lid, for sealing the water tight compartment in a watertight condition and allowing entry into said compartment when desired;
a water resistant, leak resistant water tight seal, for providing a seal between the lid and the compartment to prevent water from escaping from the compartment; and
a rigid, formable molded material, for providing shape and structure to the compartment so that the contents may be both protected and contained within.

18. An improved fishing case for safely and efficiently carrying fishing tackle, bait and accessories, comprising: a tubular, rigid tube, for containing the compartments and fishing equipment. it provides for a secure, protective, enclosure that permits easy carrying, securable protection and serves as a foundation for interior compartments;
a flexible, durable, securably fastenable securing strap, for placing the two halves of the tube into a closed and securable position. preventing others from accessing the contents without proper authorization;
a durable, securable strap locks, for locking the securing straps to prevent accidental or unauthorized entry into the tube;
a compressible, resilient, cushioning padding, for providing a soft padded location to safely store fishing rods, reels and other fishing components while the tube is being carried in a commercial carrier or by a person. to protect the contents from damage against shock and jarring;
a closeable, securable, openable zipper, for providing an openable storage compartment with in the padded and hard bodied portion of the tube;
an isolated compartment zippered compartment, for providing an isolated compartment to store various fishing items in while traveling or while in storage;
a rigid, formable molded divider, for providing a positive division between compartments. also for providing a location for the compartment lid to fit and seal;
an insulated, compartmentalized insulated compartment, for providing a compartment that is insulated to protect such items as bait from the ill effects caused by excessive heat;
a secureable storage compartment, for storing various fishing components such as fishing tackle or hardware to prevent it from being mixed or tangled with other fishing tackle or hardware;
a leak resistant, secureable water tight compartment, for containing live bait within to maintain its live vigorous condition;
a rectangular, rigid insulated compartment lid, for containing the contents of the compartment within said compartment and permitting entry into said compartment when desired;
a rectangular, rigid standard compartment lid, for securing the contents of a compartment within said compartment and permitting entry into said compartment when desired;
a sealable, rigid, rectangular water tight compartment lid, for sealing the water tight compartment in a watertight condition and allowing entry into said compartment when desired;
a water resistant, leak resistant water tight seal, for providing a seal between the lid and the compartment to prevent water from escaping from the compartment; and
a rigid, formable molded material, for providing shape and structure to the compartment so that the contents may be both protected and contained within.
